(19) United States
(12) Patent Application Publication
(10) Pub. No.: US 2011/0195268 A1
(43) Pub. Date: Aug. 11, 2011

(54) Wire Core Lace

(76) Inventor: Harold J. Schaffer, (US)

(21) Appl. No.: 12/702,063

(22) Filed: Feb. 8, 2010

(51) Int. Cl. A43C 1/00; D03D 25/00; D02G 3/36; B32B 15/00; B32B 7/00; B65H 81/00; B32B 3/30

(52) U.S. Cl. 428/600; 139/425 R; 428/365; 428/544; 428/608; 156/185

(57) ABSTRACT

An exemplary embodiment includes new product technology that greatly improves the lace used for shoes, boots, clothing, climbing, and other similar activities. This invention includes technology enhancements for laces that result in a lace that is substantially stronger, and more resilient than current lace technology. The lace described herein has a strong flexible multi-core design, and is capped by a metal tip that is wrapped around the ends of the lace and locked to the wire core with inverted metal prongs.

### CROSS REFERENCE TO RELATED APPLICATIONS

Application Ser. No. 12/498,366 filed Jul. 7, 2009 by H. Jason Schaffer

### STATEMENT REGARDING FEDERALLY SPONSORED RESEARCH AND DEVELOPMENT

None

### BACKGROUND

1. Technical Field

One useful embodiment or variation of the invention relates to the following field, although the invention may also relate to other fields and uses. The invention may have various embodiments and variations. A field is shoelaces. Currently no shoelaces provide sufficient strength or support. In recent years several shoelace systems and new lace technology have been introduced that look to solve this problem, but all of these inventions lack the strength and flexibility necessary to protect people from injury associated with broken or loose laces. One version of the invention detailed herein solves this problem, while enabling users to tie their shoes, boots, etc. in a manner that they have grown accustomed to over the last few hundred years. That version generally relates to a new technology for tying shoes, boots, etc., and more specifically, to a new shoelace that provides better and more long-lasting foot and ankle support.

2. Description of Related Art

Typical of the art related to widely useful embodiments and variations of the present invention are following patents and publications. The following examples of related art and its limitations are illustrative and not exclusive. Other limitations of the related art will become apparent to those skilled in the art upon study of the specification and drawings of this application. Other embodiments and variations of the invention may relate to other arts and uses. Originally designed in 1790 by Harvey Kennedy, the shoelace has remained virtually unchanged for the last 200 years. Despite tremendous technological advancements in the equipment and clothes used to propel and protect people in motion, shoelace technology has not advanced much beyond Harvey's original concept. As a result, millions of people around the world suffer serious injuries every year: physical, emotional, and financial.

Shoelaces are used to protect people in motion, and more specifically athletes, from foot and ankle injury as a result of a loose shoe. One version of the present invention is designed to improve the strength and support the shoelace provides, specifically for elite athletes that require optimum support for their ankle and feet. Every year hundreds of athletes are faced with either taking drugs or ending their careers due to severe foot or ankle injuries. A large percentage of these injuries could have been prevented if their shoe was not loose. One version of the present invention provides a new technology that will enable athletes to push the boundaries of their sport without compromising or risking the health of their feet or ankle.

U.S. Pat. No. 579,943, Mar. 30, 1897 to Kernfrohall disclosed a shoelace composed of a sheath and a single, non-metallic core. As the shoelace core is not comprised of a metallic substance, it is not sufficiently strong and is prone to break when in use. U.S. Pat. No. 4,721,468, Jan. 26, 1988 to Alexander and U.S. Pat. No. 4,842,522, Jun. 27, 1989 to Alexander both disclose a shoelace design that uses a single core and a single uncoated metallic wire. These single-core, single-wire designs are prone to breaking, especially in severe weather conditions. Publication number 2007/0226968, Oct. 4, 2007 by Valenzuela discloses a design that has a single metallic core comprised of three wires, and describes a plastic tip for the shoelace. This design is prone to breaking in a number of areas. The single metallic core is prone to breaking, and can easily penetrate the outer-most layer of fabric. In addition, the metal will rub and break down the weaker plastic tips, which will break and expose the raw metallic core to the user.

### SUMMARY

One of the widely useful embodiments and variations of the present invention may be summarized as follows. This embodiment or variation is exemplary only. Other embodiments and variations will become apparent to those skilled in the art upon study of the specification and drawings of this application. Other embodiments and variations of the invention may relate to other arts and have usefulness in those arts. One version of the invention includes new product technology that greatly improves the lace used for shoes, boots, clothing, climbing, and other similar activities. This invention includes technology enhancements for laces that result in a lace that is substantially stronger, and more resilient than current lace technology. The lace described herein has a strong flexible multi-core design, and is capped by a metal tip that is wrapped around the ends of the lace and locked to the wire core with inverted metal prongs.

### PURPOSES AND ADVANTAGES

The invention may have various embodiments and variations and may be useful in different fields and for different purposes. The purposes and advantages of the more widely useful embodiments or variations of the present invention include, but are not limited to, the following, and may include other purposes and advantages in different fields of use not listed herein:

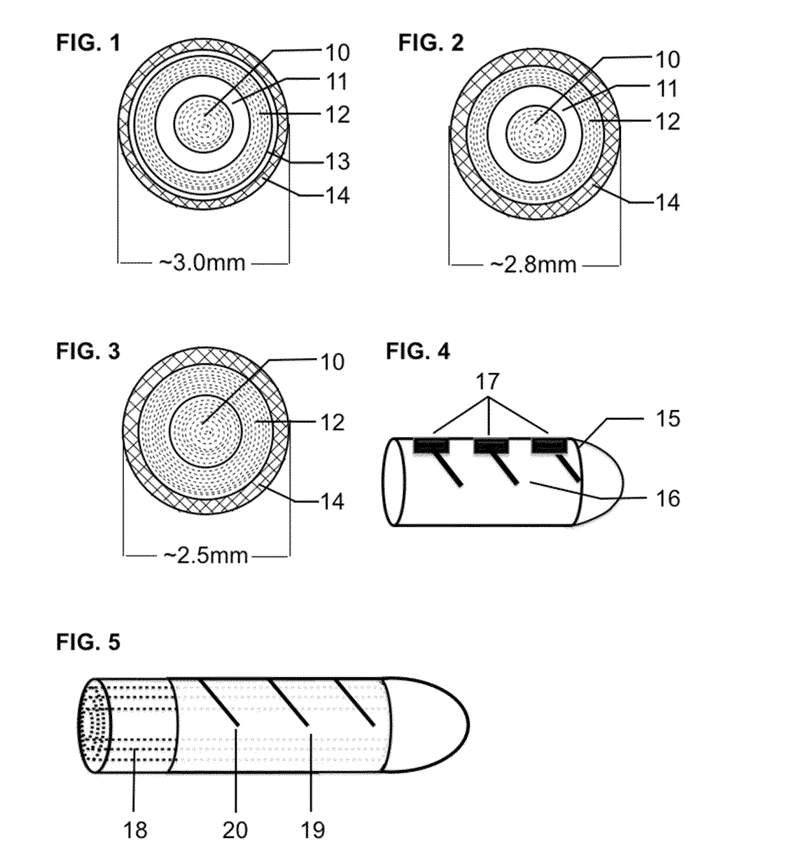

1. Lace strength. Unlike previous patents that incorporate a single wire core (e.g. U.S. Pat. Nos. 5,029,372 and 7,036,194 and 4,842,522 and 4,721,468, and publication 2007/0226,968) a multi-core lace invention described herein contains multiple wire cores. This design improvement enables products that use the lace as described in this application to be much stronger. For example, machine-driven bend tests have demonstrated that the lace (FIG. 1) has a tensile strength of up to 9.23 kgf/mm2, and can survive up to 242 years of continuous bending before breaking. Similar tests on designs like the ones in the aforementioned patents that contain a single core have tested to only 1.12 kgf/mm2, with a life cycle of less than 2 years.

2. Tip strength. Unlike previous patents that incorporate a tip into the wired lace design (e.g. publication 2007/0226,968) a lace invention described herein uses a metal tip with inverted prongs that is manufactured by the process described here to compress the lace tip to ˜3 mm or below (critical for products like shoelaces), and to secure the wired lace cores. The design defect of products that incorporate a wire, yet do not include a metal tip as described in this invention are twofold. First, the metal core will expand and contract during normal use, and due to large (˜20 degree) swings in temperature. This movement will force the metal core through the end of the non-metallic and not anchored tip. This will result in a very dangerous product, as the extended metal core is exposed and thereby capable of stabbing people in the hands when they attempt to tie their shoelace. Second, the tip design as described in publication 2007/0226,968 is highly susceptible to break during normal use, leaving the wired lace design to open.

3. Flexibility. Unlike previous patents incorporate a single plastic coating (e.g. U.S. Pat. No. 5,029,372, and publication 2007/0226,968) a multi-core lace invention described herein contains multiple layers of plastic (or like substance). This design improvement enables products that use the technology as described in the invention herein to be much more flexible, while retaining the “memory” that is inherent in the metallic core design. As a result, the designs described in the application are more easily used in products where excessive clothing is required (like underwater or in very cold temperatures).

4. Mass production. Unlike the product as described in publication 2007/0226, 968, the design improvement described herein can be produced in very large volume. The cable and shoelace industries have established methods for production of products in which the lace is spooled and distributed in bulk. The process, as described in publication 2007/0226, 968, requires “pre-selected length of a limp material with two end tips for use in tying a shoe” and to affix the tips before distribution and storage. As a result, the invention described in the publication will not be able to leverage the existing and high efficient bulk distribution and storage channels. In contrast, one variation of the invention described herein can be manufactured, spooled, and stored as unfinished goods for extended periods of time. This design change gives an advantage in distribution costs.

5. Non-conducting. Unlike the product as described in U.S. Pat. No. 5,029,372 and publication 2007/0226, 968, one variation of the invention described herein incorporates multiple layers of material that isolate the metallic threads, resulting in a product that has a superior non-conducting property. This is an advantage in applications (e.g. wireless transfers used in remote military outposts) that require the flexibility of rope and the strength to last in extreme conditions.

### REFERENCE NUMERALS IN DRAWINGS

10—shoelace core,
11—insolating layer
12—outer core,
13—shielding layer
14—outer-most layer
15—hard tip [[longer description not appropriate here; I don't want to limit to metal; some metals are not very hard}}
16—inverse prongs
17—notch
18—lace
19—hard tip side
20—inverse prongs shown penetrating the shoelace core

### BRIEF DESCRIPTION OF THE DRAWINGS

This Brief Description and the Detailed Description Of The Drawings cover only some embodiments and variations of the invention, and other embodiments and variations will be clear to those skilled in the art from the description, drawings, and Alternative and Additional Embodiments, etc. The Drawings are illustrative and not limiting.

FIG. 1 illustrates the first embodiment of the invention, a multi-core lace design.

FIG. 2 illustrates the second embodiment of the invention, a multi-core lace design. This design is different from that of FIG. 1 in that it does not have the outermost plastic layer.

FIG. 3 illustrates the third embodiment of the invention, a multi-core lace design. This design is different from that of FIG. 1 in that it does not have the outermost or innermost plastic layers, and it is different than FIG. 2 in that it does not have the innermost plastic layer.

FIG. 4 illustrates the metallic tips, for use with all three of the multi-core lace designs associated with this invention. In addition, this illustration shows the inverse-prongs that lock the lace tip to the lace core, enabling it to stay secured in extreme environments

### DETAILED DESCRIPTION OF THE DRAWINGS

FIG. 1 illustrates the first embodiment of the invention, a multi-core shoelace design. The core layer is comprised of interwoven strands for the shoelace core (10) which can be comprised of up to 26 or more strands of tinned, copper-coated steel that have been interwoven for maximum strength and flexibility. The second insolating layer (11) is a thin layer of plastic (PVC or the like) that serves to isolate and protect the inner core for damage. The third layer is the outer core (12). This layer is comprised of up to 16 or more interwoven strands of tinned, copper-coated steel, and serves to protect add strength to the lace and to protect it from over-bending and breaking, as can easily happen with prior designs in U.S. Pat. No. 4,721,468 and publication number 2007/0226968 (12). The next shielding layer (13) can be comprised of polyethylene terephthalate (PET), plastic (PVC), or a like substance, and serves to protect the underlying metallic cores. The outer-most layer (14) can be an interwoven material, such as natural fabric, artificial fabric, leather, or a combination therein. The layers are woven [[is this the best word??]], in successive order, from the core to the outer-most layer to create a tight bond and compress the materials. With this process, the entire design, including all of the layers illustrated herein, can be compressed to less than 3.2 mm (OD).

FIG. 2 illustrates the second embodiment of the invention, a multi-core shoelace design. Unlike the first embodiment, this version of the design does not include the outer, thin shielding layer (13). The shoelace core (10) is comprised of up to 26 or more interwoven strands of tinned, copper-coated steel. The isolating layer (11) can be a thin layer of plastic (PVC or the like) that serves to isolate and protect the inner core for damage. The third layer is the outer core (12). This layer is comprised of up to 16 or more interwoven strands of tinned, copper-coated steel, and serves to protect add strength to the lace and to protect it from over-bending and breaking, as can easily happen with prior designs in U.S. Pat. No. 4,721,468 and publication number 2007/0226968. The outer-most layer (14) is a material, such as natural fabric, artificial fabric, leather, or a combination therein that has been threaded on top, and thereby integrated with, the underlying layers.

FIG. 3 illustrates the third embodiment of the invention, a multi-core shoelace design. Unlike the first and second embodiments, this version of the design does not include the outer, thin plastic shielding layer (13), or the second layer, a thin isolating layer of plastic (11). The shoelace core (10) is comprised of up to 26 or more interwoven strands of tinned, copper-coated steel for the shoelace core. The second layer is the outer core (12). This layer is comprised of up to 16 or more interwoven strands of tinned, copper-coated steel, and serves to protect add strength to the lace and to protect it from over-bending and breaking, as exists with prior designs in U.S. Pat. No. 4,721,468 and publication number 2007/0226968. The outer-most layer (14) is a material, such as natural fabric, artificial fabric, leather, or a combination therein that has been threaded on top, and thereby integrated with, the underlying layers.

FIG. 4 illustrates the tips constructed of a very hard substance (e.g. metal), (15) that enclose and encapsulate the end of the laces as described in embodiments in FIGS. 1, 2, and 3. The very hard substance that forms the tip in this illustration is wrapped around the multi-core lace (18) (shown in FIG. 5) to form a single protective layer on all sides. Tips constructed of a very hard substance are used to help users grip the lace (18), and to ensure that the shoelace core (10) cannot punch through the distal ends of the lace (18) when used with high frequency in multi-climate environments. In addition, by wrapping the hard tip around the multi-core wired lace, the layers of the lace are more tightly compressed than traditional glue tips can provide. In addition, FIG. 4 illustrates a distinct and important element of the invention. On one side of hard tip (19) are three distinctive notches (17). These notches are the locations of the metal inverse prongs (16) that extend from the hard tip (15) inward, connecting the hard tip to the core wired layers of the lace. The inverse prongs are inverted, driven into the lace core and pointing toward the end of the hard tip, as shown in FIG. 5. This design helps ensure that the shoelace core (10) and hard tip (15) of the lace stay locked together when in use.

FIG. 5 illustrates how the hard tip is used with and a key element of the multi-core lace as described in this invention. Shown in this illustration is the lace (18) with the hard tip side (19) wrapped around, and compressing, and the inverse prongs (20) [that connect the tip with the core wired layers (18).

### Preferred Embodiment

The embodiment or variation of the invention as show in FIG. 1 is the embodiment presently preferred by the Inventor, but over time other embodiments and variations and uses in other areas may become preferred to those skilled in the art.

### Operation of One Embodiment

The invention, as illustrated in the embodiment shown in FIG. 1 and claim ______, is currently used to create shoelaces that will never break, always stay tied, and can be easily tied when a person's physical capabilities are impaired (e.g. when gloves are worn or in extreme temperatures). Hundreds of American soldiers have successfully used the product in combat by replacing their standard issue military bootlaces with the laces described in this invention. To use the invention (i.e. wired laces), the user ties the laces in the same manner, and with the same technique, that he uses to tie traditional shoelaces.

### Tests of One Embodiment

In our simulated or test environment, we have demonstrated that the multi-core lace invention as described here has a tensile strength of up to 9.23 kgf/mm2, and can survive up to 242 years of daily use before breaking. This information is based on two separate test environments. In one test, we measured the amount of times the multi-core wired lace could be bent without breaking. To conduct the test we used a machine that attaches at the ends of the sample and bends the lace around a steel cylinder. The machine bends the lace at a load of 100 g, around a steel cylinder 180 degrees (back-and-forth) at 20 cycles per minute until it breaks. This test mimics typical of shoelace tying, and is used to screen for production defects and to compare the strength of one variation of the invention versus that of existing technologies. This test was last performed on a production run that ended Nov. 19 2009. For that test, the design as described in FIG. 2—lasted 13,225 bends before breaking, while the design described in FIG. 1—lasted 88,224 bends before breaking. The product design, or requirements, threshold for this test is 10,000 bends and 75,000 bends respectively. In a second test, we measure the tensile strength of one version of the invention by using a static hydraulic tensile system. To conduct the test, the wired core lace is secured by clamping the ends of the lace by mechanical means. Once secured, the hydraulic system slowly increases the load until the design reaches its breaking point. As of Dec. 21, 2009, we have conducted this test over twenty times. This test is not used in production quality checks; it is merely used to compare a version of the invention described herein with existing products and patented technology that has yet to be productized. In testing we found that existing products and technologies for shoelaces (as an example), cannot exceed a tensile strength of ˜1.12 kgf/mm2. In contrast one version of the invention described herein can withstand up to ˜9.23 kgf/mm2 (FIG. 1).

The United States, Army Special Forces have been in trials with military boot versions of the invention with tremendous success. In 2009 over 500 laces were used in combat missions. At the end of the trials, the Department of Defense, Special Operations Task Force issued a strong letter of recommendation for the product, saying of the invention “we have tested their (wired laces) strength time and time again and they have continued to perform at a very high level . . . 85% of the personnel that utilized the laces asked to receive additional pairs.”

### Additional Embodiments

The invention described herein could be interwoven into a large “fabric” layer, by replacing one (or more) of the rope threads with a core wire lace, as described herein. The resulting product will be a high strength rope, used for activities such as mountain climbing or boating.

The invention described herein could be used to replace the nylon, leather or other laces used in athletic equipment (e.g. baseball gloves, lacrosse sticks, and driving shoes).

The invention described herein could be used aid children, the elderly, or the disabled with tying their shoes. The core wired lace technology can be used to create shoelaces that are designed for people with special needs (i.e. children, elderly, and disabled persons).

### Alternative Embodiments

To accommodate various products and uses of this technology, the materials can be changed and the layers of the lace can be shifted in size and location. For example, the two wired cores could be placed near the outer-most layer of the lace to increase the rigidness for products that will be used in very hot environments (e.g. military operations in the desert or hot running data centers). In addition, other stiff material could be used instead of the tinned, copper-coated steel as described in the embodiments, as necessary to adjust the hardness, density, malleability, and ductility of the end product. For example, copper could be used as the core element to increase the pliability and make it easier for the elderly to use. Alternatives include, but are not limited to, the following: copper, steel, aluminum, and tin. In addition, the outer-most layer of fabric can be substituted for other material as necessary to make the end product suitable for the target environment. For example, to improve the safety of fire fighters the outer-most layer could be constructed of a Kevlar-based material.

### CONCLUSIONS, RAMIFICATIONS AND SCOPE

A number of changes are possible to the methods, parts, and uses described above while still remaining within the scope and spirit of the invention. The specifics about the form and use of the invention described in this application (including the specifics in the Background, Field, Related Art, Summary, Purposes and Advantages, Abstract, Preferred Embodiment, Additional Embodiments, and Alternative Embodiments, Descriptions of the Drawings, etc.) are examples and are not intended to be limiting in scope. Those skilled in the art will recognize certain variations, modifications, permutations, additions, subtractions and sub-combinations thereof, and may discover new fields of use. The scope of the invention is to be determined by the claims and their legal equivalents, not the examples, purposes, summary, preferred embodiments, alternative or additional embodiments, operation, tests, parameters, or limitations etc. given above. It is intended that the claims are interpreted to include all such variations, modifications, additions, subtractions, permutations and sub-combinations as are within their true spirit and scope, including those which may be recognized later by those skilled in the art.

I claim:

1. A multi-core lace technology that greatly improves the strength of traditional laces, used in products such as shoelaces and ropes, and comprises up to five distinct layers with two interwoven metal and non-metallic cores.

2. A lace as recited in claim 1, wherein the innermost core is comprised of up to 26 interwoven strands of thin, water-resistant metal.

3. A lace as recited in claim 1, wherein the innermost core is coated with a plastic material.

4. A lace as recited in claim 1, wherein a secondary metallic core is comprised of up to 16 interwoven strands of thin, water-resistant metal.

5. A lace as recited in claim 1, wherein the secondary metallic core is coated with a plastic material.

6. A lace as recited in claim 1, wherein the outermost layer is comprised of material suitable for external use, like natural or man-made fabric.

7. A multi-core lace technology that greatly improves the strength of traditional laces, used in products such as shoelaces and ropes, and comprises up to 4 distinct layers with two interwoven metal and non-metallic cores.

8. A lace as recited in claim 7, wherein the innermost core is comprised of up to 26 interwoven strands of thin, water-resistant metal.

9. A lace as recited in claim 7, wherein the innermost core is coated with a plastic material.

10. A lace as recited in claim 7, wherein a secondary metallic core is comprised of up to 16 interwoven strands of thin, water-resistant metal.

11. A lace as recited in claim 7, wherein the outermost layer is comprised of material suitable for external use, like natural or man-made fabric.

12. A multi-core lace technology that greatly improves the strength of traditional laces, used in products such as shoelaces and ropes, and comprises up to 3 distinct layers with two interwoven metal and non-metallic cores.

13. A lace as recited in claim 12, wherein the innermost core is comprised of up to 26 interwoven strands of thin, water-resistant metal.

14. A lace as recited in claim 12, wherein a secondary metallic core is comprised of up to 16 interwoven strands of thin, water-resistant metal.

15. A lace as recited in claim 12, wherein the outermost layer is comprised of material suitable for external use, like natural or man-made fabric.

16. A process for manufacturing the multi-core lace product as described in claims 1-15, that interweaves and compresses the lace, building up from one layer to the next.

17. A metallic tip technology that greatly improves the strength of the tip used for products like shoelaces.

18. A metal tip as described in claim 17, wherein one side of the metal tip has three distinctive notches.

19. A metal tip as described in claim 17, wherein the metal tip includes three inverse metal prongs that are connected to the lace core, and toward the head, to enable the tip not to fall off when using the multi-core lace technology described herein.

20. A method of producing the metal tip as described in claim 17, wherein said metal tip is wrapped around the tip of the multi-core lace.
